(19) United States
(12) Patent Application Publication
(10) Pub. No.: US 2023/0289291 A1
(43) Pub. Date: Sep. 14, 2023

(54) CACHE PREFETCH FOR NEURAL PROCESSOR CIRCUIT

(71) Applicant: Apple Inc., Cupertino, CA (US)

(72) Inventors: Seungjin Lee, Los Gatos, CA (US); Jaewon Shin, Los Altos, CA (US); Christopher L Mills, Saratoga, CA (US)

(21) Appl. No.: 17/691,609

(22) Filed: Mar. 10, 2022

(51) Int. Cl. G06F 12/0862

(52) U.S. Cl. CPC G06F 12/0862; G06F 2212/602

(57) ABSTRACT

A neural processor may include a system memory access circuit coupled to a system memory. The system memory access circuit is configured to fetch, from the system memory, first input data of a first task associated with a neural network. The neural processor may also include neural engines coupled to the system memory access circuit. The neural engines are configured to perform convolution operations on the first input data in a first set of operating cycles. The neural processor may further include a cache access circuit coupled to a cache. The cache access circuit is configured to instruct the cache to prefetch from the system memory, during the first set of operating cycles corresponding to the first task, second input data of a second task of the neural network. The second task is scheduled for processing in a second set of operating cycles after the first set of operating cycles.

### BACKGROUND

### 1. Field of the Disclosure

The present disclosure relates to a circuit for performing operations related to neural networks, and more specifically to fetching of data in neural processor circuits.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations including multiplication and accumulation. For example, CNN is a class of machine learning techniques that primarily uses convolution between input data and kernel data, which can be decomposed into multiplication and accumulation operations.

Depending on the types of input data and operations to be performed, these machine learning systems or models can be configured differently. Such varying configurations would include, for example, pre-processing operations, the number of channels in input data, kernel data to be used, non-linear function to be applied to convolution result, and applying of various post-processing operations. Using a central processing unit (CPU) and its main memory to instantiate and execute machine learning systems or models of various configurations is relatively easy because such systems or models can be instantiated with mere updates to code. However, relying solely on the CPU for various operations of these machine learning systems or models would consume significant bandwidth of a central processing unit (CPU) as well as increase the overall power consumption.

Electronic devices that are equipped with a neural processor specialized in performing computations related to machine learning models have become increasingly more common. Machine learning operations often involve a large amount of data, and therefore, access to data can become a bottleneck for the entire process. Slow access to data could adversely impact the performance of a neural processor.

### SUMMARY

Embodiments relate to a neural processor circuit that includes a system memory access circuit coupled to a system memory. The system memory access circuit is configured to fetch, from the system memory, first input data of a first task associated with a neural network. The neural processor circuit also includes one or more neural engine circuits coupled to the system memory access circuit. The one or more neural engine circuits are configured to perform convolution operations on the first input data in a first set of operating cycles. The neural processor circuit further includes a cache access circuit coupled to a cache circuit that caches data to or from the system memory. The cache access circuit is configured to instruct the cache circuit to prefetch from the system memory, during the first set of operating cycles corresponding to the first task, second input data of a second task of the neural network. The second task is scheduled for processing in a second set of operating cycles subsequent to the first set of operating cycles.

### BRIEF DESCRIPTION OF THE DRAWINGS

FIG. 1 is a high-level diagram of an electronic device, according to one embodiment.

FIG. 2 is a block diagram illustrating components in the electronic device, according to one embodiment.

FIG. 3 is a block diagram illustrating a neural processor circuit, according to one embodiment.

FIG. 4 is a block diagram of a neural engine in the neural processor circuit, according to one embodiment.

FIG. 5 is a block diagram of a planar engine in the neural processor circuit, according to one embodiment.

FIG. 6A is a conceptual diagram illustrating data flow and bandwidth allocation in a prefetch process, according to one embodiment.

FIG. 6B are graphs illustrating the bandwidth allocation and memory footprint of a system memory and a cache circuit for various tasks, according to one embodiment.

FIG. 7A is a conceptual diagram illustrating data flow and bandwidth allocation for a prefetch process that uses a sieve filtering operation, according to one embodiment.

FIG. 7B are graphs illustrating the bandwidth allocation and memory footprint of a system memory and a cache circuit for various tasks in a prefetch process that uses sieve filtering, according to one embodiment.

FIG. 8 is a flowchart depicting an example process for determining data flow associated with a neural processor circuit, according to one embodiment.

The figures depict, and the detailed description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to a neural processor that causes a cache circuit to prefetch input data of a neural network from system memory. Some of the neural network structure is predetermined. The tasks that correspond to the neural network may be scheduled in the neural processor. The prefetch operation prefetches input data that is scheduled for later operating cycles from system memory to the cache circuit before a request for the input data is made. In some high bandwidth tasks, the data consumption rate can be higher than the bandwidth supported by the system memory. As such, the speed of those tasks may be bound by the bandwidth of the system memory. Prefetching the input data to the cache circuit may eliminate or reduce stalls in those tasks as the cache circuit has a higher data rate than the system memory.

### Example Electronic Device

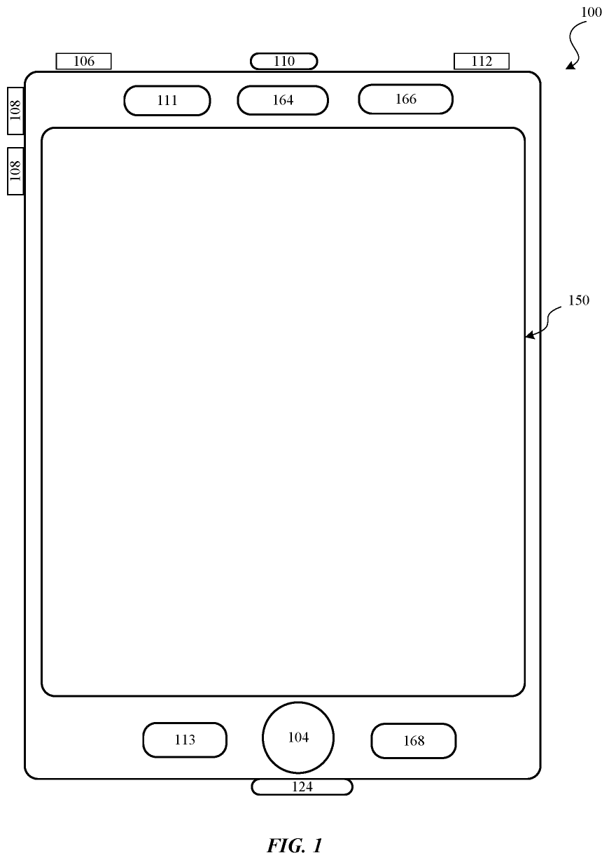

Embodiments of electronic devices, user interfaces for such devices, and associated processes for using such devices are described. In some embodiments, the device is a portable communications device, such as a mobile telephone, that also contains other functions, such as a personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, Calif. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

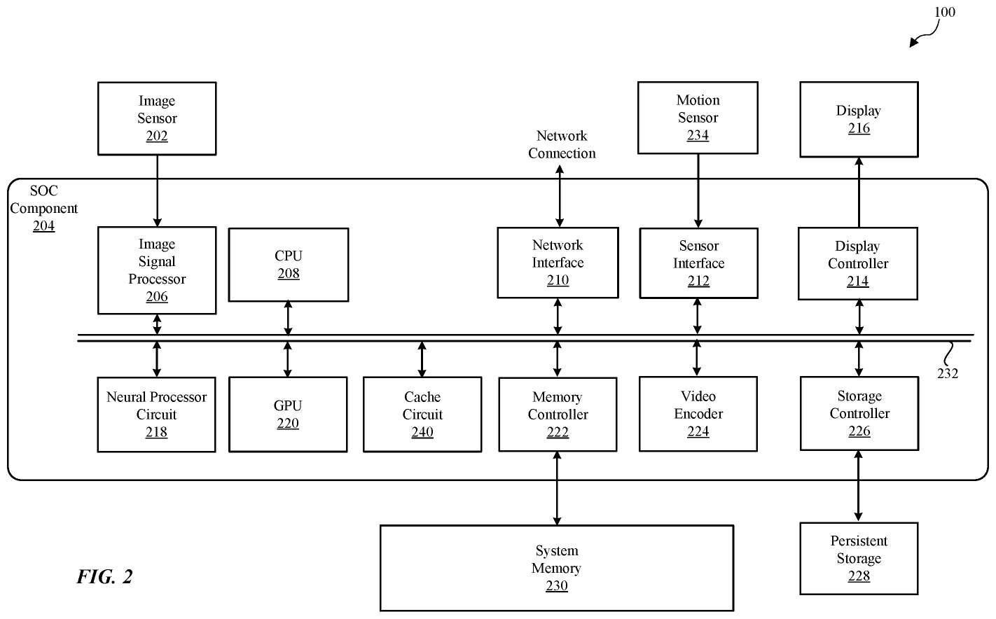

FIG. 2 is a block diagram illustrating components in device 100, according to one embodiment. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computations used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, cache circuit 240 and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

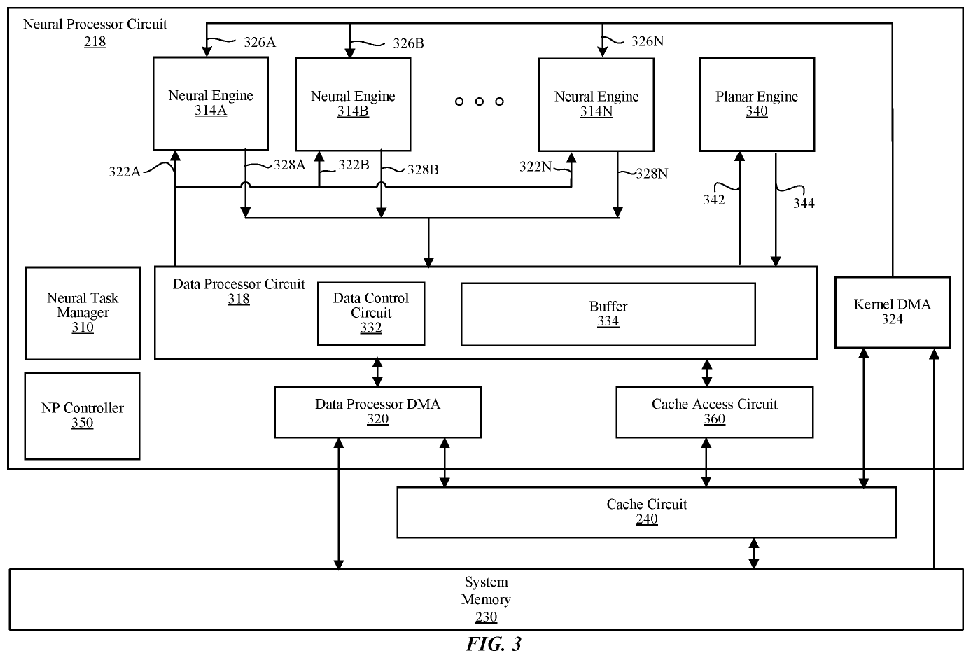

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, the image signal processor 206, persistent storage 228, system memory 230 or other sources such as network interface 210 or GPU 220. The output of neural processor circuit 218 may be provided to various components of device 100 such as image signal processor 206, system memory 230 or CPU 208 for various operations. The structure and operation of neural processor circuit 218 are described below in detail with reference to FIG. 3.

Cache circuit 240 may be a system cache of SOC component 204. Cache circuit 240 may be located near the peripherals and the memory controller 222 and outside of CPU 208. Cache circuit 240 may be a faster, smaller, and closer to neural processor circuit 218 than the system memory 230. Cache circuit 240 caches data from system memory 230 and has a faster data rate than system memory 230. In one embodiment, cache circuit 240 may be a last-level cache that is shared by one or more processors such as CPU 208, GPU 220, image signal processor 206 and neural processor circuit 218. In other embodiments, cache circuit 240 may also have divided sections that are reserved for particular processors. Machine learning operations that are computed by neural processor circuit 218 may have large data sizes. Some of the processes may be system memory bandwidth bound. Cache circuit 240 increases the data access rate to improve the performance of data-heavy processors such as neural processor circuit 218.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 128 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as hidden layers. Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computational operations such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network are discussed as an example, the neural processor circuit 218 may also be used for the operations of other types of machine learning models, such as a kernel SVM. For simplicity, this disclosure may describe operations of neural networks, but the operations can also be used for other types of machine learning models.

Referring to FIG. 3, an example neural processor circuit 218 may include, among other components, neural task manager 310, a plurality of neural engines 314A through 314N (hereinafter collectively referred to as “neural engines 314” and individually also referred to as “neural engine 314”), kernel direct memory access (DMA) 324, data processor circuit 318, data processor DMA 320, planar engine 340, neural processor (NP) controller 350, and cache access circuit 360. Neural processor circuit 218 may include fewer components than what are illustrated in FIG. 3 or include additional components not illustrated in FIG. 3.

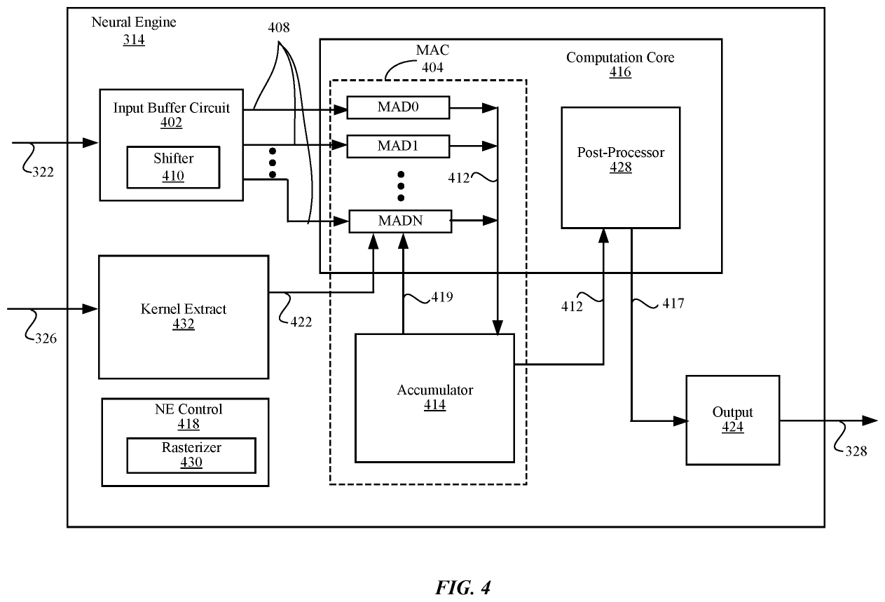

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, and for post-processing to generate an output data 328, as described below in detail with reference to FIG. 4. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions.

Planar engine 340 may specialize in performing simpler computing operations whose speed may primarily depend on the input and output (I/O) speed of the data transmission instead of the computation speed within planar engine 340. These computing operations may be referred to as I/O bound computations and are also referred to as “non-convolution operations” herein. In contrast, neural engines 314 may focus on complex computation such as convolution operations whose speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In one embodiment, input data may be a tensor whose rank is larger than three (e.g., having three or more dimensions). A set of dimensions (two or more) in the tensor may be referred to as a plane while another dimension may be referred to as a channel. Neural engines 314 may convolve data of a plane in the tensor with a kernel and accumulate results of the convolution of different planes across different channels. On the other hand, planar engine 340 may specialize in operations within the plane.

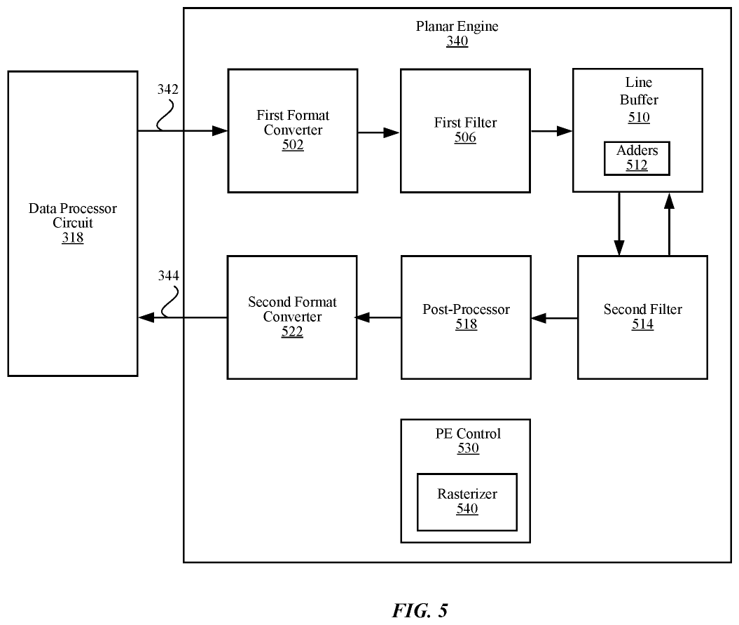

The circuitry of planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar). The operations of planar engine 340 will be discussed in further detail below with reference to FIG. 5.

Neural task manager 310 manages the overall operation of neural processor circuit 218. Neural task manager 310 may receive a task list from a compiler executed by CPU 208, store tasks in its task queues, choose a task to perform, and send task commands to other components of the neural processor circuit 218 for performing the chosen task. Data may be associated with a task command that indicates the types of operations to be performed on the data. Data of the neural processor circuit 218 includes input data that is transmitted from another source such as system memory 230, and data generated by the neural processor circuit 218 in a previous operation cycle. Each dataset may be associated with a task command that specifies the type of operations to be performed on the data. Neural task manager 310 may also perform switching of tasks on detection of events such as receiving instructions from CPU 208. In one or more embodiments, neural task manager 310 sends rasterizer information to the components of neural processor circuit 218 to enable each of the components to track, retrieve or process appropriate segments of the input data and kernel data. For example, neural task manager 310 may include registers that store the information regarding the size and rank of a dataset for processing by the neural processor circuit 218. Although neural task manager 310 is illustrated in FIG. 3 as part of neural processor circuit 218, neural task manager 310 may be a component outside the neural processor circuit 218.

Kernel DMA 324 is a read circuit that fetches kernel data from a source (e.g., system memory 230) and sends kernel data 326A through 326N to each of the neural engines 314. Kernel data represents information from which kernel elements can be extracted. In one embodiment, the kernel data may be in a compressed format which is decompressed at each of neural engines 314. Although kernel data provided to each of neural engines 314 may be the same in some instances, the kernel data provided to each of neural engines 314 is different in most instances. In one embodiment, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a data control circuit 332 and a buffer 334. Buffer 334 is temporary storage for storing data associated with operations of neural processor circuit 218, such as input data that is transmitted from system memory 230 (e.g., data from a machine learning model) and other data that is generated within neural processor circuit 218. The input data may be transmitted from system memory 230. The data stored in data processor circuit 318 may include different subsets that are sent to various downstream components, such as neural engines 314 and planar engine 340.

In one embodiment, buffer 334 is embodied as a non-transitory memory that can be accessed by neural engines 314 and planar engine 340. Buffer 334 may store input data 322A through 322N (also referred to as “neural input data” herein) for feeding to corresponding neural engines 314A through 314N and input data 342 (also referred to as “planar input data” herein) for feeding to planar engine 340, as well as output data 328A through 328N from each of neural engines 314A through 314N (also referred to as “neural output data” herein) and output data 344 from planar engine 340 (also referred to as “planar output data” herein) for feeding back into one or more neural engines 314 or planar engine 340, or sending to a target circuit (e.g., system memory 230). Buffer 334 may also store input data 342 and output data 344 of planar engine 340 and allow the exchange of data between neural engine 314 and planar engine 340. For example, one or more output data 328A through 328N of neural engines 314 are used as planar input data 342 to planar engine 340. Likewise, planar output data 344 of planar engine 340 may be used as the input data 322A through 322N of neural engines 314. The inputs of neural engines 314 or planar engine 340 may be any data stored in buffer 334. For example, in various operating cycles, the source datasets from which one of the engines fetches as inputs may be different. The input of an engine may be an output of the same engine in previous cycles, outputs of different engines, or any other suitable source datasets stored in buffer 334. Also, a dataset in buffer 334 may be divided and sent to different engines for different operations in the next operating cycle. Two datasets in buffer 334 may also be joined for the next operation.

Data control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Data control circuit 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., the data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to the planar engine 340 to direct planar engine 340 to program itself for operating in one of multiple operation modes.

The data of neural processor circuit 218 stored in buffer 334 may be part of, among others, image data, histogram of oriented gradients (HOG) data, audio data, metadata, output data 328 of a previous cycle of a neural engine 314, and other processed data received from other components of the SOC component 204.

Data processor DMA 320 includes a read circuit that receives a portion of the input data from a source (e.g., system memory 230) for storing in buffer 334, and a write circuit that forwards data from buffer 334 to a target component (e.g., system memory). In one embodiment, the direct memory access nature of data processor DMA 320 may allow data processor DMA 320 to fetch and write data directly from a source (e.g., system memory 230) without the involvement of CPU 208. Buffer 334 may be a direct memory access buffer that stores data of a machine learning model of device 100 without the involvement of CPU 208.

Neural Processor (NP) controller 350 is a control circuit that performs various operations to control the overall operation of neural processor circuit 218. NP controller 350 may interface with CPU 208, program components of neural processor circuit 218 by setting register in the components and perform housekeeping operations. NP controller 350 may also initialize components in neural processor circuit 218 when neural processor circuit 218 is turned on.

Cache access circuit 360 is a control and read circuit that is coupled to cache circuit 240, which may be the system cache of SOC component 204. Cache access circuit 360 may instruct the cache circuit 240 to prefetch data from system memory 230. The type of data prefetched to cache circuit 240 may include kernel data that is normally handled by kernel DMA 324 and tensor datasets that may be processed by data processor circuit 318. In some cases, the entirety of the data may be prefetched to cache circuit 240 to increase the data access rate compared to directly fetching the data from system memory 230. In other cases, to also utilize any unused bandwidth of system memory 230, data may be partially prefetched to cache circuit 240. During the cycle of operations of the data, part of the data is fetched from cache circuit 240 and the remaining is directly fetched from system memory 230. The process of dividing the data to fetch the data from both cache circuit 240 and system memory 230 may be referred to as sieve. Cache access circuit 360 may be controlled by neural task manager 310, which provides instructions on fetching and prefetching of data based on parameters in the task descriptors such as prefetching instructions and sieve factors.

### Example Neural Engine Architecture

FIG. 4 is a block diagram of neural engine 314, according to one embodiment. Neural engine 314 is a circuit that performs various operations to facilitate machine learning such as convolution, tensor product, and other operations may involve heavy computation. For this purpose, neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or span across multiple channels.

Neural engine 314 may include, among other components, input buffer circuit 402, computation core 416, neural engine (NE) control 418, kernel extract circuit 432, accumulator 414 and output circuit 424. Neural engine 314 may include fewer components than what is illustrated in FIG. 4 or include further components not illustrated in FIG. 4.

Input buffer circuit 402 is a circuit that stores a subset of the data of neural processor circuit 218 as the subset of data is received from a source. The source may be data processor circuit 318, planar engine 340, or another suitable component. Input buffer circuit 402 sends an appropriate portion 408 of data for a current task or process loop to computation core 416 for processing. Input buffer circuit 402 may include a shifter 410 that shifts read locations of input buffer circuit 402 to change portion 408 of data sent to computation core 416. By changing portions of input data provided to computation core 416 via shifting, neural engine 314 can perform multiply-accumulate for different portions of input data based on a fewer number of read operations. In one or more embodiments, the data of neural processor circuit 218 includes data of difference convolution groups and/or input channels.

Kernel extract circuit 432 is a circuit that receives kernel data 326 from kernel DMA 324 and extracts kernel coefficients 422. In one embodiment, kernel extract circuit 432 references a lookup table (LUT) and uses a mask to reconstruct a kernel from compressed kernel data 326 based on the LUT. The mask indicates locations in the reconstructed kernel to be padded with zero and the remaining locations to be filled with numbers. Kernel coefficients 422 of the reconstructed kernel are sent to computation core 416 to populate register in multiply-add (MAD) circuits of computation core 416. In other embodiments, kernel extract circuit 432 receives kernel data in an uncompressed format and the kernel coefficients are determined without referencing a LUT or using a mask.

Computation core 416 is a programmable circuit that performs computation operations. For this purpose, computation core 416 may include MAD circuits MAD0 through MADN and a post-processor 428. Each of MAD circuits MAD0 through MADN may store an input value in the portion 408 of the input data and a corresponding kernel coefficient in kernel coefficients 422. The input value and the corresponding kernel coefficient are multiplied in each of MAD circuits to generate a processed value 412.

Accumulator 414 is a memory circuit that receives and stores processed values 412 from MAD circuits. The processed values stored in accumulator 414 may be sent back as feedback information 419 for further multiply and add operations at MAD circuits or sent to post-processor 428 for post-processing. Accumulator 414 in combination with MAD circuits form a multiply-accumulator (MAC) 404. In one or more embodiments, accumulator 414 may have subunits where each subunit sends data to different components of neural engine 314. For example, during a processing cycle, data stored in a first subunit of accumulator 414 is sent to the MAC circuit while data stored in a second subunit of accumulator 414 is sent to post-processor 428.

Post-processor 428 is a circuit that performs further processing of values 412 received from accumulator 414. Post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values 417 to output circuit 424. In some embodiments, the processing at the post-processor 428 is bypassed. For example, the data in accumulator 414 may be sent directly to output circuit 424 for access by other components of neural processor circuit 218.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator 414 to MAD circuits, and perform different types of post-processing operations at post-processor 428. To configure components of neural engine 314 to operate in a desired manner, the NE control 418 sends task commands that may be included in information 419 to components of neural engine 314. NE control 418 may include a rasterizer 430 that tracks the current task or process loop being processed at neural engine 314.

Input data is typically split into smaller pieces of data for parallel processing at multiple neural engines 314 or neural engines 314 and planar engine 340. A set of data used for a convolution operation may be referred to as a convolution group, which can be split into multiple smaller units. The hierarchy of smaller units (portions of data) may be convolution groups, slices, tiles, work units, output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a portion of the input data, such as data processed by planar engine 340 or data processed a prior cycle of neural engines 314 having a size that produces output values that fit into accumulator 414 of neural engine 314 during a single cycle of the computation core 416. In one case, the size of each work unit is 256 bytes. In such embodiments, for example, work units can be shaped to one of 16×16, 32×8, 64×4, 128×2 or 256×1 datasets. In the context of planar engine 340, a work unit may be (i) a portion of input data, (ii) data from neural engine 314 or (iii) data from a prior cycle of planar engine 340 that can be processed simultaneously at planar engine 340.

Rasterizer 430 may perform the operations associated with dividing the input data into smaller units (portions) and regulate the processing of the smaller units through the MACs 404 and accumulator 414. Rasterizer 430 keeps track of sizes and ranks of portions of the input/output data (e.g., groups, work units, input channels, output channels) and instructs the components of a neural processor circuit 218 for proper handling of the portions of the input data. For example, rasterizer 430 operates shifters 410 in input buffer circuits 402 to forward correct portions 408 of input data to MAC 404 and send the finished output data 328 to data buffer 334. Other components of neural processor circuit 218 (e.g., kernel DMA 324, data processor DMA 320, data buffer 334, planar engine 340) may also have their corresponding rasterizers to monitor the division of input data and the parallel computation of various portions of input data in different components.

Output circuit 424 receives processed values 417 from post-processor 428 and interfaces with data processor circuit 318 to store processed values 417 in data processor circuit 318. For this purpose, output circuit 424 may send out as output data 328 in a sequence or a format that is different from the sequence or format in which the processed values 417 are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processor 428.

### Example Planar Engine Architecture

FIG. 5 is a block diagram of planar engine 340, according to one embodiment. Planar engine 340 is a circuit that is separated from neural engines 314 and can be programmed to perform in different modes of operations. For example, planar engine 340 may operate in a pooling mode that reduces the spatial size of data, in a reduction mode that reduces the rank of a tensor, in a gain-and-bias mode that provides a single-pass addition of bias and scaling by a scale factor, and in an elementwise mode that includes elementwise operations. For this purpose, planar engine 340 may include, among other components, a first format converter 502, a first filter 506 (also referred to herein as “multi-mode horizontal filter 506”), a line buffer 510, a second filter 514 (also referred to herein as “multi-mode vertical filter 514”), a post-processor 518, a second format converter 522, and a planar engine (PE) control 530 (includes rasterizer 540). Planar engine 340 may include fewer components or further components not illustrated in FIG. 5A. Each component in planar engine 340 may be embodied as a circuit or a circuit in combination with firmware or software.

Input data 342 of planar engine 340 may be fetched from one or more source datasets that are saved in data processor circuit 318. If a dataset to be processed by planar engine 340 is larger than a work unit of data that can be simultaneously processed by planar engine 340, such dataset may be segmented into multiple work units for reading as input data 342 to planar engine 340. Depending on the mode of planar engine 340, input data 342 may include data from one or more source datasets. The source dataset described herein refers to different data saved in neural processor circuit 218 for processing. Different components of neural processor circuit 218 may generate or transmit data that is saved in data processor circuit 318. For example, neural engines 314, planar engine 340 (which generated data in a previous operation cycle), and system memory 230 may generate or transmit different datasets that are saved in different memory locations of data processor circuit 318. Various source datasets may represent different tensors. In an operation cycle of planar engine 340, different source datasets may be fetched together as input data 342. For example, in an elementwise mode that involves the addition of two different tensors to derive a resultant tensor, the input data 342 may include data from two different source datasets, each providing a separate tensor. In other modes, a single source dataset may provide input data 342. For example, in a pooling mode, input data 342 may be fetched from a single source dataset.

First format converter 502 is a circuit that performs one or more format conversions on input data 342 in one format (e.g., a format used for storing in buffer 334) to another format for processing in subsequent components of planar engine 340. Such format conversions may include, among others, the following: applying a ReLU function to one or more values of input data 342, converting one or more values of input data 342 to their absolute values, transposing a tensor included in the sources, applying gain to one or more values of input data 342, biasing one or more values of input data 342, normalizing or de-normalizing one or more values of input data 342, converting floating-point numbers to signed or unsigned numbers (or vice versa), quantizing numbers, and changing the size of a tensor such as by broadcasting a value of a tensor in one or more dimensions to expand the rank of the tensor. The converted input data 342 and unconverted input data 342 to planar engine 340 are collectively referred to herein as “a version of the input data.”

First filter 506 is a circuit that performs a filtering operation in one direction. For this purpose, first filter 506 may include, among other components, adders, comparators, and multipliers. The filtering performed by first filter 506 may be, for example, averaging, choosing a maximum value or choosing a minimum value. When averaging, adders are used to sum the values of input data 342 and a weighting factor may be applied to the sum using a multiplier to obtain the average as the resultant values. When selecting maximum and minimum values, the comparators may be used in place of the adders and the multipliers to select the values.

Line buffer 510 is a memory circuit for storing the result such as one or more intermediate data obtained from first filter 506 or second filter 514. Line buffer 510 may store values of different lines and allows access from second filter 514 or other downstream components to fetch the intermediate data for further processing. In some modes, line buffer 510 is bypassed. Line buffer 510 may also include logic circuits to perform additional operations other than merely storing the intermediate data. For example, line buffer 510 includes adder circuits 512, which in combination with memory component, enables line buffer 510 to function as an accumulator that aggregates data generated from the results of first filter 506 or second filter 514 to separately store aggregated data of a dimension not to be reduced.

Similar to first filter 506, second filter 514 performs filtering operations but in a direction different from first filter 506. For this purpose, second filter 514 may include, among other components, adders, comparators, and multipliers. In the pooling mode, first filter 506 performs filtering operation in a first dimension, while second filter 514 performs filtering operation in a second dimension. In other modes, first filter 506 and second filter 514 may operate differently. In a reduction mode, for example, first filter 506 performs elementwise operations while second filter 514 functions as a reduction tree to aggregate values of data.

Post-processor 518 is a circuit that performs further processing of values fetched from other upstream components. Post-processor 518 may include specialized circuits that are efficient at performing certain types of mathematical computations that might be inefficient to perform using a general computation circuit. Operations performed by post-processor 518 may include, among others, performing square root operations and inverse of values in a reduction mode. Post-processor 518 may be bypassed in other operation modes.

Second format converter 522 is a circuit that converts the results of preceding components in planar engine 340 from one format to another format for output data 344. Such format conversions may include, among others, the following: applying a ReLU function to the results, transposing a resultant tensor, normalizing or de-normalizing one or more values of the results, and other number format conversions. Output data 344 may be stored in data processor circuit 318 as the output of neural processor circuit 218 or as inputs to other components of neural processor circuit 218 (e.g., neural engine 314).

PE control 530 is a circuit that controls operations of other components in planar engine 340 based on the operation mode of planar engine 340. Depending on the different modes of operation, PE control 530 programs register associated with the different components in planar engine 340 so that the programmed components operate in a certain manner. The pipeline of components or connections between the components in planar engine 340 may also be reconfigured. In the pooling mode, for example, data processed by first filter 506 may be stored in line buffer 510 and then be read by second filter 514 for further filtering. In the reduction mode, however, data is processed by first filter 506, then processed at second filter 514 and then accumulated in line buffer 510 that is programmed as an accumulator. In the elementwise mode, line buffer 510 may be bypassed.

PE control 530 also includes a rasterizer 540 that tracks the current task or process loop being processed at planar engine 340. Rasterizer 540 is a circuit that tracks units or portions of input data and/or loops for processing the input data in planar engine 340. Rasterizer 540 may control the fetch of portions to planar engine 340 in each operation cycle and may monitor the size and rank of each portion being processed by planar engine 340. For example, smaller portions of a dataset may be fetched as input data 342 in a raster order for processing at planar engine 340 until all portions of the source dataset are processed. In fetching the portions, rasterizer 540 monitors the coordinate of the portion in the dataset. The manner in which a dataset is segmented into input data 342 for processing at planar engine 340 may be different compared to how a dataset is segmented into input data 328 for processing at neural engines 314.

The dataset for processing at planar engine 340 may be larger than the capacity of planar engine 340 that can be processed in a single operation cycle. In such a case, planar engine 340 fetches different portions of the dataset as input data 342 in multiple operating cycles. The fetched portion may partly overlap with a previously fetched portion and/or the next portion to be fetched. In one embodiment, the portion of overlapping data is fetched only once and reused to reduce the time and power consumption cost of planar engine 340 in fetching data.

### Example Prefetch Operation

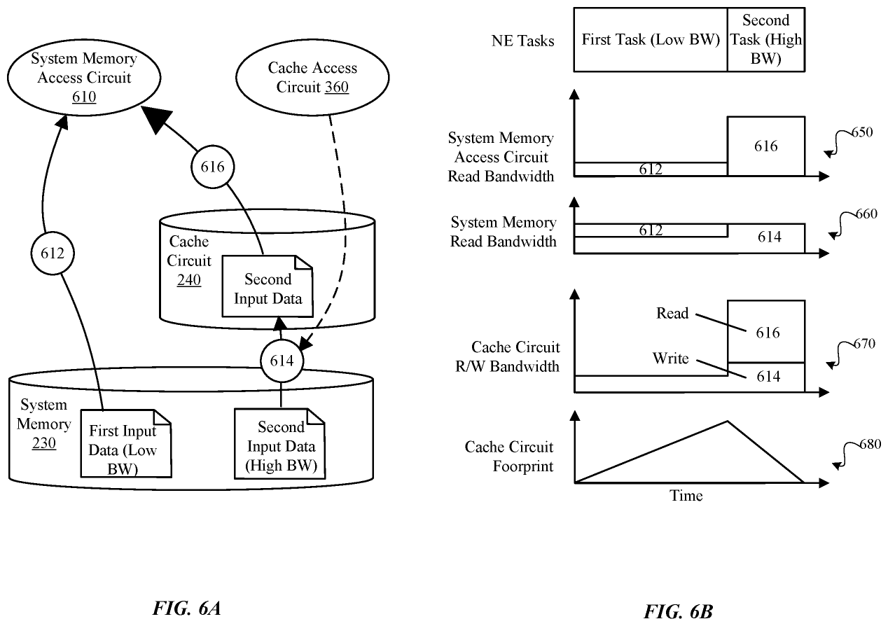

FIG. 6A is a conceptual diagram illustrating data flow and bandwidth allocation in a prefetch process, according to an embodiment. The prefetch process illustrated in FIG. 6A is discussed using a neural network and the network's kernel data, but other machine learning models, computation operations, and datasets may also be used in the prefetch process described in FIG. 6A. The prefetch process involves neural processor circuit 218, cache circuit 240, and system memory 230. Components of neural processor circuit 218 involved include kernel DMA 324, data processor DMA 320, neural engine 314, neural task manager 310 and cache access circuit 360. Reference is made to FIG. 3 with respect to components of neural processor circuit 218.

In training and making inference, a neural network includes various operations that may be carried out in various sets of operating cycles of neural processor circuit 218. For example, a neural network may include multiple layers such as a first layer, a second layer, and other layers. Operations in the first layer of the neural network may include a first task that involves convolution operations of first input data. The first input data may be kernel data, or convolution data (e.g., image data, audio data or other data to be subject to convolution operations). In the example illustrated in FIG. 6A, kernel data is used as an example but the prefetch operation may also be used for the convolution data. As such, the access circuit for data access of system memory 230 may be data processor DMA 320, kernel DMA 324, or another suitable access circuit. In FIG. 6A, the access circuit may be referred to as a system memory access circuit 610, which is coupled to system memory 230. The first task may be scheduled to be performed in a first set of operating cycles. Operating cycles may be internal cycles of neural processor circuit 218. For example, an operating cycle may be a clock cycle or a fixed number of clock cycles of neural processor circuit 218. Operations in a second layer of the neural network may include the second task that involves convolutional operations of second input data. The second task may be scheduled for processing in a second set of operating cycles subsequent to the first set of operating cycles, whether the second set of operating cycles is immediately after the first set or there are other tasks between the two sets of operating cycles. Neural task manager 310 may control the sequence and execution of various tasks associated with the neural network.

Neural task manager 310 may determine that the first input data, which may be the first kernel data, has a small size compared to the bandwidth allocation from system memory 230. For example, in some embodiments, the kernel sizes of a neural network are fixed or at least known when the code representing the neural network is compiled. Kernel data that has smaller dimensions or size may have an overall smaller size and may be regarded as low bandwidth data. Fetching the first input data from system memory 230 may use less than an allocated bandwidth of system memory 230, such as the bandwidth allocated to neural processor circuit 218 at a given time.

During the first set of operating cycles, system memory access circuit 610 fetches 612 the first input data from system memory 230. In turn, system memory access circuit 610 transmits the fetched first input data to one or more neural engine circuits 314. The one or more neural engine circuits 314 perform convolution operations on the first input data in the first set of operating cycles. For example, a neural engine circuit 314 may convolve the kernel data with the convolution data to generate outputs with respect to the first layer of the neural network.

In one embodiment, during the first set of operating cycles corresponding to the first task, cache access circuit 360 instructs cache circuit 240 to prefetch 614 from system memory 230 the second input data of the second task of the neural network. The second task may be scheduled for the second set of operating cycles that are subsequent to the first set of operating cycles. The second input data may have a larger size compared to the first input data. For example, the second input data may be large kernel data compared to the first input data. The second input data may be determined as high bandwidth data that may cause the second task to be memory bound. For example, if the second input data is only directly fetched from system memory 230 during the second set of operating cycles, the speed of completing the second task may be limited by the bandwidth of system memory 230. Since fetching of the first input data may use less than the bandwidth of system memory 230, prefetching the second input data from system memory 230 to the cache circuit 240 may use at least part of the remaining bandwidth of system memory 230. The second input data fetched to cache circuit 240 may be stored in cache circuit 240 during the first set of operating cycles and remain unconsumed in cache circuit 240 until the second set of operating cycles.

During the second set of operating cycles, the second input data is fetched 616 from cache circuit 240 to neural processor circuit 218 for processing. Since the speed of cache circuit 240 is higher than system memory 230, the overall completion speed of the second task may be increased. The second input data may be sent to one or more neural engine circuits 314 to perform convolution operations on the second input data in the second set of operating cycles.

FIG. 6B are graphs illustrating the bandwidth allocation and memory footprint of system memory 230 and cache circuit 240 for various tasks, according to an embodiment. Graph 650 illustrates the read bandwidth of system memory access circuit 610 during the operating cycles corresponding to the low bandwidth task and the high bandwidth task. During the operating cycles corresponding to the low bandwidth task, system memory access circuit 610 reads the first input data and the bandwidth usage corresponds to step 612. During the operating cycles corresponding to the high bandwidth task, system memory access circuit 610 reads the second input data from cache circuit 230 and the bandwidth usage corresponds to step 616.

Graph 660 illustrates the read bandwidth usage of system memory 230 for a low bandwidth task and a high bandwidth task if prefetching is performed. During the low bandwidth task, part of the bandwidth of system memory 230 is allocated to prefetching of high bandwidth data from system memory 230 to cache circuit 240. As such, the bandwidth of system memory 230 is better allocated. During the high bandwidth task, system memory 230 has a reduced read activity compared to a process that has no prefetch, thereby alleviating the demand for system memory 230 and speeding up the data access.

Graph 670 illustrates the read and write bandwidth usage of cache circuit 240 for the low bandwidth task and the high bandwidth task if prefetching is performed. During the low bandwidth task, cache circuit 240 is used to prefetch the second input data. Hence, there are write activities during the low bandwidth task. During the high bandwidth task, data from system memory 230 may be fetched to neural processor circuit 218 via cache circuit 240. Hence, there are still write activities during the high bandwidth task. The write activities correspond to step 614. System memory access circuit 610 may also fetch the second input data that is prefetched in cache circuit 240. As such, read activities, which correspond to step 616, are also shown during the high bandwidth task.

Graph 680 illustrates the memory footprint of cache circuit 240 for prefetching the second input data. Data is written to cache circuit 240 and the space occupied continues to increase during the low bandwidth task. During the high bandwidth task, the data prefetched starts to be consumed by neural processor circuit 218 and the memory footprint begins to decrease.

### Example Sieve Filtering Operation

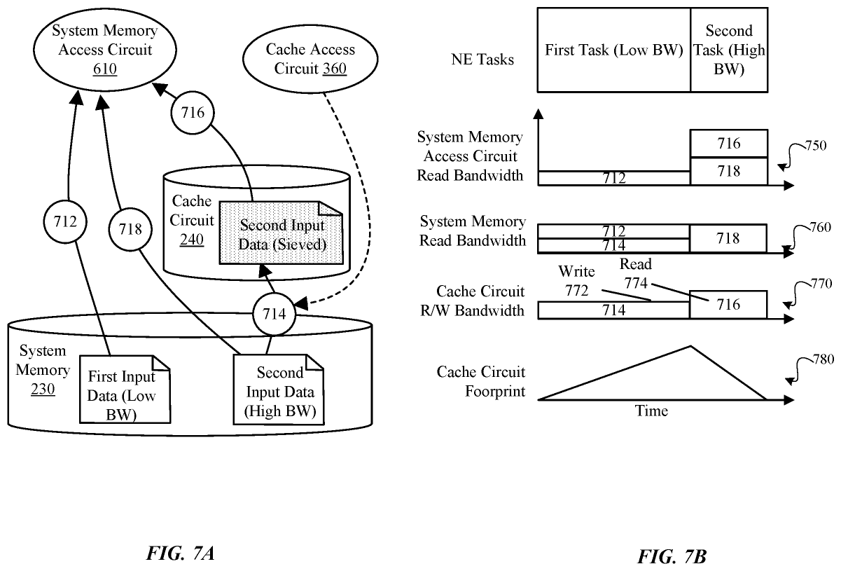

FIG. 7A is a conceptual diagram illustrating data flow and bandwidth allocation for a prefetch process that uses a sieve filtering operation, according to an embodiment. Similar to FIG. 6A, the prefetch process illustrated in FIG. 7A is discussed using a neural network and the network's kernel data, but other machine learning models, computation operations, and datasets may also be used in the prefetch process. Likewise, the prefetch process involves neural processor circuit 218, cache circuit 240, and system memory 230. Components of neural processor circuit 218 involved include kernel DMA 324, data processor DMA 320, neural engine 314, neural task manager 310 and cache access circuit 360. Reference is made to FIG. 3 with respect to components of neural processor circuit 218.

Similar to FIG. 6A, FIG. 7A is illustrated using a low bandwidth task and a high bandwidth task. The low bandwidth task may be referred to as the first task, which may be scheduled to be performed in a first set of operating cycles. The high bandwidth task may be referred to as the second task. The second task may be scheduled for processing a second set of operating cycles subsequent to the first set of operating cycles, whether the second set is immediately after the first set or not.

A sieve filtering operation may refer to a prefetch operation that only prefetches part of the data in an input dataset and receives the remaining input dataset directly from system memory 230. For example, an input dataset may be divided into different subsets based on one or move sieve factors. The sieve factors indicate how the dataset is divided and whether a particular divided subset should be prefetched. In a sieve filtering operation, some of the subsets of the input data are prefetched to cache circuit 240 while other subsets remain in system memory 230. In contrast, the second input data in the example illustrated in FIG. 6A is fetched through cache circuit 240. Sieve filtering may be used when the footprint of cache circuit 240 is limited or when there is insufficient time to prefetch all of the data. In some embodiments, sieve filtering may be performed by skipping transactions at a certain ratio. The decision to skip is made on a sieve granularity (e.g., 1 KB) to ensure the resulting request pattern is amenable to system memory 230.

To illustrate the sieve filtering operation, the data flow in the first set of operating cycles is first discussed. When performing the sieve filtering operation, neural task manager 310 determines that the first input data, which may be the first kernel data, has a small size with respect to the bandwidth allocation from system memory 230. In the first set of operating cycles, system memory access circuit 610 fetches 712 the first input data from system memory 230. Same as the process illustrated in FIG. 6, fetching of the first input data from system memory 230 may use less than an allocated bandwidth of system memory 230, such as the bandwidth allocated to neural processor circuit 218 at a given time.

During the same first set of operating cycles, cache access circuit 360 instructs cache circuit 240 to prefetch 714, from system memory 230, a first portion of the second input data based on sieve factors in the task descriptor of the second task. The second task may be an example of a high bandwidth task where the second input data is relatively large with respect to the bandwidth allocation from system memory 230. Only part of the second input data is prefetched to cache circuit 240. The remaining second input data (e.g., a second portion) remains in system memory 230.

During the second set of operating cycles, the second input data is fetched to neural processor circuit 218 from both cache circuit 240 and system memory 230. Since the second set of operating cycles is assigned to the second task which processes the second input data, system memory 230 would become idle if the entire second input data has already been prefetched to cache circuit 240. As such, in the sieve filtering operation, part of the second input data is fetched 718 directly from system memory 230 to better utilize the bandwidth of system memory. For example, the first portion of the second input data is prefetched 714 to the cache circuit 240 and the second portion of the second input data is fetched 718 from the system memory 230 during the second set of operating cycles.

FIG. 7B is graphs illustrating the bandwidth allocation and memory footprint of system memory 230 and cache circuit 240 for various tasks in a prefetch process that uses sieve filtering, according to an embodiment. Graph 750 illustrates the read bandwidth of system memory access circuit 610 during the operating cycles corresponding to the low bandwidth task and the high bandwidth task. During the operating cycles corresponding to the low bandwidth task, system memory access circuit 610 reads the first input data and the bandwidth usage corresponds to step 712. During the operating cycles corresponding to the high bandwidth task, system memory access circuit 610 reads the second input data from both cache circuit 230 and system memory 230. The bandwidth usage corresponds to the sum of step 716 and step 718.

Graph 760 illustrates the read bandwidth usage of system memory 230 for a low bandwidth task and a high bandwidth task. During the operating cycles corresponding to the low bandwidth task, system memory 230 provides the first input data that is used in the low bandwidth task. The bandwidth allocation corresponds to step 712. Part of the bandwidth of system memory 230 is allocated to prefetching of the first portion of high bandwidth data from system memory 230 to cache circuit 240, which corresponds to step 714. During the operating cycles corresponding to the high bandwidth task, system memory 230 allocates bandwidth for the fetching of the second portion of the second input data based on the sieve factor. The fetching corresponds to step 718. Since the remaining of the second input data has been prefetched to cache circuit 240, the read bandwidth reliance on system memory 230 is reduced compared to a process without prefetch.

Graph 770 illustrates the read and write bandwidth usage of cache circuit 240 for the low bandwidth task and the high bandwidth task. During the operating cycles corresponding to the low bandwidth task, cache circuit 240 is used to prefetch part of the second input data based on the sieve factor. The prefetch process corresponds to step 714. Hence, there are write activities 772 during the low bandwidth task. During the operating cycles corresponding to the high bandwidth task, system memory access circuit 710 fetches part of the second input data that is stored in cache circuit 240. As such, read activities 774 correspond to step 716. Compared to graph 670 in FIG. 6B, the bandwidth reliance on the cache circuit 240 is reduced in graph 770. Therefore, sieve filtering may reduce the demand on cache circuit 240 and improve performance.

Graph 780 illustrates the memory footprint of cache circuit 240 for prefetching the second input data. Data is written to cache circuit 240 and the space occupied by the written data continues to increase during the low bandwidth task. During the high bandwidth task, the data prefetched starts to be consumed by neural processor circuit 218 and the memory footprint begins to decrease.

### Example Data Flow Determination Process

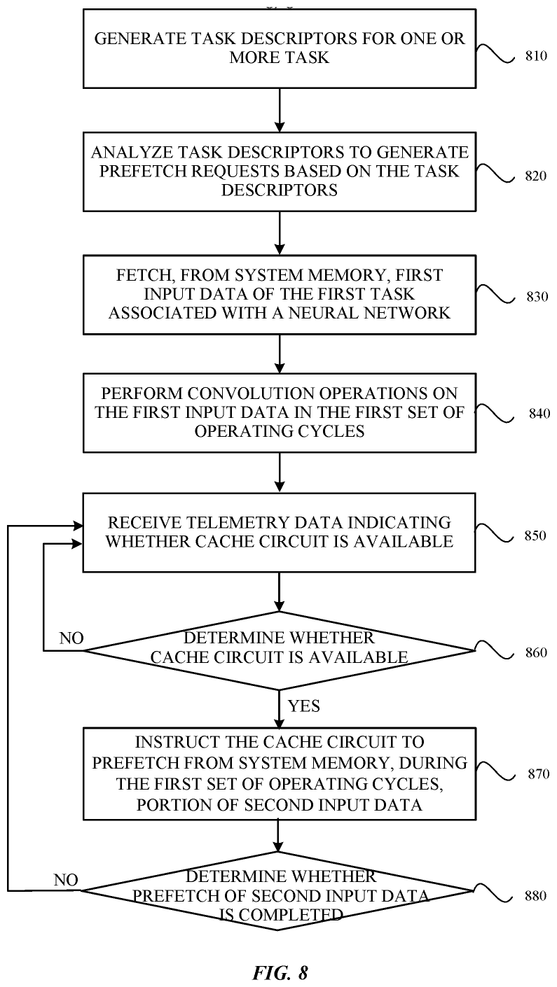

FIG. 8 is a flowchart depicting an example process for determining data flow associated with neural processor circuit 218, according to an embodiment. The process may be performed by various components in an electronic device 100 in executing the code instructions associated with a neural network. The process determines what tasks are to be executed in running the neural network and how data are provided to neural processor circuit 218.

In one embodiment, in executing a neural network, tasks that need to be executed, such as convolution operation tasks, pooling tasks, etc. may be defined in by a compiler. A compiler may define a first task that corresponds to a first operation in a first layer of the neural network and a second task that corresponds to a second operation in a second layer of the neural network. Certain structures and data sizes of the neural network are defined in the code instructions associated with the neural networks. As such, the sizes of certain data in various layers, such as kernel data, may be predetermined and known to the compiler. The compiler may analyze the neural network and identify tasks that may be system memory bandwidth bound. For example, the compiler may determine that a size of input data for neural processor circuit 230 exceeds a threshold and the rate of operation associated with the computation of the input data may be bound by the bandwidth of system memory 230. The tasks associated with those input data may be referred to as high bandwidth tasks that are illustrated in FIG. 6A through FIG. 7B. For illustration purposes, the second task is described here as a high bandwidth task.

The compiler may also generate 810 task descriptors for one or more tasks. A task descriptor includes a set of metadata that is used to describe a task. The metadata may define data size and location, task operations, prefetch instructions, and sieve factors. A task descriptor defines a configuration of components in the neural processor circuit 218 to execute the task associated with the task descriptor. Each task descriptor for a task may include a task descriptor header and configuration registers. The task descriptor header comprises configurations related to the task manager's behavior for the task. For example, the task descriptor header may be written at the beginning of each task descriptor. The task descriptor header includes a plurality of fields. The fields may include a task ID, a network ID, an estimated number of operating cycles required to execute the task to execute, a prefetch instruction that indicates whether the input data should be prefetched, data size and location, and a sieve factor indicating whether and how the sieve filtering may be carried out. The task descriptors are sent to the neural task manager 310 of neural processor circuit 218 to set the operations of the neural task manager 310 and other components of neural processor circuit 218.

Neural processor circuit 218, such as via neural task manager 310, may analyze 820 task descriptors to generate prefetch requests based on the task descriptors. For example, the first task may be determined to be a low bandwidth task and may be associated with a task descriptor that does not include a prefetch instruction. The second task may be determined to be a high bandwidth task and may be associated with a task descriptor indicating that the second input data associated with the second task is to be prefetched to the cache circuit 240. One or more neural engine circuits 314 of neural processor circuit 218 may also carry out operations according to the task descriptor. The prefetch operation may be scheduled to be carried out in the first set of operating cycles corresponding to the execution of the first task, but the timing of the prefetch operation may depend on various factors such as the availability of cache circuit 240 and the sieve factor associated with the second task. In some cases, due to the unavailability of cache circuit 240, the prefetch operation may be delayed. If the prefetch operation is not able to be carried out until the second set of operating cycles that are scheduled for the execution of the second task, the prefetch operation may be canceled and the second input data may be fetched directly from system memory 230.

A system memory access circuit 610 may fetch 830, from system memory 230, the first input data of the first task associated with a neural network. The first task is scheduled for processing in the first set of operating cycles, which may be defined in the task descriptor. One or more neural engine circuits 314 may perform 840 convolution operations on the first input data in the first set of operating cycles. For example, the first input data may be the first kernel data corresponding to the first layer in the neural network. The kernel data may be convolved with pixel data of the first layer.

Neural processor circuit 218, such as via cache access circuit 360, may receive 850 telemetry data indicating whether cache circuit 240 is available. The telemetry data may indicate the bandwidth of cache circuit 240 allocated to neural processor circuit 218. For example, cache circuit 240 may be shared by one or more processing circuits (e.g., CPU 208, GPU 220, etc.) and the bandwidth of cache circuit 240 may be used up by another processing circuit. Cache access circuit 360 determines 840 whether cache circuit 240 is available. In response to receiving the telemetry data indicating that cache circuit 240 is unavailable, cache access circuit 360 may enter a back-off state. In the back-off state, cache access circuit 360 backs off from instructing cache circuit 240 to perform a prefetch operation until a predetermined period of time has elapsed. The telemetry back off may be part of a data traffic control operation associated with cache circuit 240. During the back-off state, cache access circuit 360 may intermittently poll cache circuit 240. In one embodiment, cache access circuit 360 remains in the back-off state as long as the telemetry data indicates cache circuit 240 is unavailable. The wait interval before another poll is issued may be increased by a factor of N (e.g., 2) for each poll, starting from a minimum time and capped at a maximum time. The back-off may be similar to exponential backoff in network collision.

In response to receiving the telemetry data indicating that cache circuit 240 is available, a prefetch operation may occur. For example, cache access circuit 360 may instruct 870 the cache circuit 240 to prefetch from system memory 230, during the first set of operating cycles corresponding to the first task, a portion of second input data of a second task of the neural network. Details of the prefetching operation are illustrated in FIG. 6A and FIG. 7A.

In some embodiments, while a prefetch request for the second input data of the second task is issued, the prefetch operation may not be completed or may only be partially completed when neural processor circuit 218 reaches the second set of operating cycles. For example, the prefetch operation may be delayed due to the telemetry data indicating that cache circuit 240 is unavailable or the bandwidth of the cache circuit 240 for the prefetch operation is limited. In the case where the prefetch operation is not started at the beginning of the second set of operating cycles, the second input data may be fetched from system memory 230. In some cases, the prefetch may be partially completed based on the sieve factor described in the task descriptor. For example, the sieve factor may specify that sieve filtering is performed by skipping transactions at a certain ratio. The decision to skip is made on a sieve granularity indicated by the sieve factor (e.g., 1 KB) to ensure the resulting request pattern is amenable to system memory 230. Hashing in the cache circuit 240 allows the cache lines to be evenly distributed among sets after sieve filtering, despite the filtering happening in virtual address space and resulting in a periodic pattern in the request addresses. In some embodiments, the fetching of the second input data may be divided between system memory 230 and cache circuit 240, whether equally or not. For example, in some embodiments, since cache circuit 240 has a faster data rate, the majority of second input data may be prefetched to cache circuit 240. In some embodiments, the sieve filtering may be dynamic. The extent of prefetching may be dynamically determined based on the availability of cache circuit 240, which may be shared by one or more processing circuits external to the neural processor circuit 218 (e.g., CPU 208, GPU 220, and image signal processor 206) for caching data.

The granularity of the prefetch operation in prefetching the second input data may also depend on the implementations in different embodiments. For example, each time the telemetry data that indicates cache circuit 240 is available is received 850, cache access circuit 360 may prefetch 870 a fixed size of second input data. For example, in one embodiment, cache access circuit 360 requests telemetry data for every 128 bytes of data prefetched. The granularity may vary depending on embodiment. Cache access circuit 360 may determine 880 whether the prefetch of the second input data is completed. If the prefetch operation is not completed, cache access circuit 360 continues to receive 850 telemetry data to attempt to complete the prefetch operation when the cache circuit 240 becomes available.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A neural processor circuit, comprising:
a system memory access circuit coupled to a system memory, the system memory access circuit configured to fetch, from the system memory, first input data of a first task associated with a neural network;
one or more neural engine circuits coupled to the system memory access circuit, the one or more neural engine circuits configured to perform convolution operations on the first input data in a first set of operating cycles; and
a cache access circuit coupled to a cache circuit that caches data to or from the system memory, the cache access circuit configured to instruct the cache circuit to prefetch from the system memory, during the first set of operating cycles corresponding to the first task, second input data of a second task of the neural network scheduled for processing in a second set of operating cycles subsequent to the first set of operating cycles.

2. The neural processor circuit of claim 1, wherein the first task corresponds to a first operation in a first layer of the neural network and the second task corresponds to a second operation in a second layer of the neural network, the second layer being different from the first layer.

3. The neural processor circuit of claim 1, wherein fetching the first input data from the system memory uses less than a bandwidth of the system memory and prefetching the second input data from the system memory to the cache circuit uses at least part of the bandwidth of the system memory.

4. The neural processor circuit of claim 1, wherein the second input data prefetched to the cache circuit remains unconsumed in the cache circuit until the second set of operating cycles.

5. The neural processor circuit of claim 1, wherein the second task is associated with a task descriptor indicating that the second input data is to be prefetched to the cache circuit, wherein the one or more neural engine circuits of the neural processor circuit are configured perform an operation according to the task descriptor.

6. The neural processor circuit of claim 5, wherein the task descriptor is generated by a compiler that is configured to analyze the neural network and determining that a size of second input data exceeding a threshold.

7. The neural processor circuit of claim 1, wherein a first portion of the second input data is prefetched to the cache circuit and the system memory access circuit is further configured to fetch a second portion of the second input data from the system memory during the second set of operating cycles.

8. The neural processor circuit of claim 7, wherein prefetching the first portion to the cache circuit and fetching the second portion from the system memory are controlled by one or more sieve factors in a task descriptor associated with the second task.

9. The neural processor circuit of claim 1, wherein the cache circuit is shared by one or more processing circuits external to the neural processor circuit for caching data.

10. The neural processor circuit of claim 1, wherein the cache access circuit is further configured to receive telemetry data indicating whether the cache circuit is available.

11. The neural processor circuit of claim 10, wherein the cache access circuit is further configured to, responsive to receiving the telemetry data indicating that the cache circuit is unavailable, backing off from instructing the cache circuit to perform a prefetching operation until a period of time has elapsed.

12. A method comprising:
fetching, by a system memory access circuit from a system memory, first input data of a first task associated with a neural network;
perform, by one or more neural engine circuits, convolution operations on the first input data in a first set of operating cycles; and
instructing, a cache access circuit coupled to a cache circuit that caches data to or from the system memory, the cache circuit to prefetch from the system memory, during the first set of operating cycles corresponding to the first task, second input data of a second task of the neural network scheduled for processing in a second set of operating cycles subsequent to the first set of operating cycles.

13. The method of claim 12, wherein the first task corresponds to a first operation in a first layer of the neural network and the second task corresponds to a second operation in a second layer of the neural network, the second layer being different from the first layer.

14. The method of claim 12, wherein fetching the first input data from the system memory uses less than a bandwidth of the system memory and prefetching the second input data from the system memory to the cache circuit uses at least part of the bandwidth of the system memory.

15. The method of claim 12, wherein a first portion of the second input data is prefetched to the cache circuit and a second portion of the second input data is fetched from the system memory during the second set of operating cycles.

16. The neural processor circuit of claim 15, wherein prefetching the first portion to the cache circuit and fetching the second portion from the system memory are controlled by one or more sieve factors in a task descriptor associated with the second task.

17. The method of claim 12, further comprising receiving telemetry data indicating whether the cache circuit is available.

18. The method of claim 17, further comprising:
responsive to receiving the telemetry data indicating that the cache circuit is unavailable, backing off from instructing the cache circuit to perform a prefetching operation until a period of time has elapsed.

19. An electronic device, comprising:
a system memory configured to store a neural network; and
a neural processor circuit, comprising:
a system memory access circuit coupled to the system memory, the system memory access circuit configured to fetch, from the system memory, first input data of a first task associated with the neural network;
one or more neural engine circuits coupled to the system memory access circuit, the one or more neural engine circuits configured to perform convolution operations on the first input data in a first set of operating cycles; and
a cache access circuit coupled to a cache circuit that caches data to or from the system memory, the cache access circuit configured to instruct the cache circuit to prefetch from the system memory, during the first set of operating cycles corresponding to the first task, second input data of a second task of the neural network scheduled for processing in a second set of operating cycles subsequent to the first set of operating cycles.

20. The electronic device of claim 19, wherein the first task corresponds to a first operation in a first layer of the neural network and the second task corresponds to a second operation in a second layer of the neural network, the second layer being different from the first layer.
